(19) United States
(12) Patent Application Publication
(10) Pub. No.: US 2006/0231683 A1
(43) Pub. Date: Oct. 19, 2006

(54) Aircraft & motor vehicle protection system that eliminates eleven safety and environmental hazards associated with aircraft and vehicles parked or tied down and exposed to the elements and animals

(76) Inventor: James R. Orr, Davenport, IA (US)

Correspondence Address: James R. Orr, 4721 Wisconsin Avenue, Davenport, IA, 52806, US

(21) Appl. No.: 11/108,595

(22) Filed: Apr. 18, 2005

(51) Int. Cl. B64C 1/00

(52) U.S. Cl. 244/133

(57) ABSTRACT

The Aircraft & motor vehicle protection system invention eliminates the safety and environmental hazards associated with the safety and environmental elements such as (1) sun, (2) heat, (3) thunderstorms, (4) hail, (5) rain & fuel contamination, (6) bird and animal nesting and droppings, (7) freezing rain, (8) frost, (9) ice, (10) snow, and (11) extreme cold that are possibly introduced to aircraft and ground vehicles parked or tied down and exposed to the elements and animals. The invention, which utilizes inflatable/deflatable modules to form the complete system, with multiple layers of protection, with each layer eliminating one or more of the eleven hazards, ensures the elimination of the hazardous concerns associated with parked aircraft increases the percentages for safe flight, reduces the opportunity for damage to the aircraft and assists in maintaining the value of the aircraft. This invention also provides the protection for ground vehicles.

### BACKGROUND OF THE INVENTION

(1) Technical Field

This invention provides the ability to maintain and protect the structural integrity of an aircraft and increases the safety margins for the safe operation of an aircraft that has been tied down outside for any duration of time.

(2) Background Information

An aircraft is a very expensive asset and very vulnerable to deterioration and or damage as the result of being exposed to the elements and to destructive weather phenomena. The same scenario exists for ground vehicles.

Modern aircraft that are parked outside in the elements for short or lengthy durations of time are exposed to four very separate and distinct concerns that can cause instant damage or long term deterioration to the aircraft. Exposure to the elements without protection can, one, increase the risk of unsafe flight, two, damage the aircraft and its components, three, reduce the value of the aircraft and four, possibly contaminate the fuel supply.

The exterior and interior of an aircraft are constructed with materials that are very susceptible to deterioration and damage from various environmental elements such as (1) sun, (2) heat, (3) thunderstorms, (4) hail, (5) rain & fuel contamination, (6) bird and animal nesting and droppings, (7) freezing rain, (8) frost, (9) ice, (10) snow, and (11) extreme cold.

The safety and environmental concerns associated with the first six hazards are outlined below:

(1) The ultraviolet rays from the sun damages the paint surfaces, the glass, Plexiglas and the exterior appendages such as antennas, lights and lenses. An aircraft sitting unprotected on the tarmac for any period of time, will experience subtle but very expensive UV deterioration, which reduces the value of the aircraft.

(2) The constant thermal change to the metal, composite material, carbon fiber, or other aircraft material and paint caused by the heating and cooling during the normal daily, weekly and yearly heating/cooling cycles introduce stress to the exterior of the aircraft, fades the paint and reduces the integrity and life of the structure of the aircraft. An aircraft sitting unprotected on the tarmac for any period of time, in the boiling sun, will experience subtle but very expensive deterioration and damage, and reduce the value of the aircraft.

(1 & 2) The UV and thermal damage caused to the avionics and other interior portions of the aircraft is dramatic and very expensive. The sun shortens the life of the sophisticated and extremely expensive navigational equipment and fades the interior. A “closed up” aircraft sitting unprotected on the tarmac for any period of time, in the boiling sun, will experience dramatic increased temperatures inside the aircraft approaching and sometimes exceeding 150 degrees, which damages the avionics and sophisticated equipment in the aircraft and reduces the long term value of the aircraft and reduces the reliability of the avionics.

(3 & 4) The exterior of the aircraft is constructed with materials that are very susceptible to damage and deterioration from thunderstorms and hailstorms.

(3 & 4) Thunderstorms can blow up in a matter of minutes, and the thunderstorm with possible hailstorm damage can damage the aircraft beyond repair in a matter of moments. The damage from hail can and many times does render the aircraft unsafe for flight. Damage from hailstorms can and many times does damage the aircraft to such an extent that the value of the aircraft is reduced dramatically. In some instances, if the hail damage is significant, the value of an aircraft may be reduced by more than fifty percent, and possibly even approaching a total loss. When the aircraft is damaged in this scenario, the aircraft must be removed from service and the owners will no longer have access to this asset for business or pleasure use until the repairs are completed.

(4) Hailstorm damage to an aircraft changes the aerodynamics of the aircraft. All the hail dimples on the fuselage, wings, especially the leading edges, and the horizontal and vertical stabilizers can, and many instances does, change the lift and stall characteristics for that particular aircraft. Changes in the aerodynamics of the aircraft alters all the dynamic handling characteristics of the aircraft, which makes the plane operate outside the envelope of the pilot's operating handbook. Operating outside the window is unsafe and introduces numerous opportunities for accident, injury and death.

(3 & 4) The thunderstorms and hailstorm damage may damage the windscreen, radar dome, radar unit, antennas and other appendages that are necessary for safe flight. The cost of repair or replacement is extremely expensive and until the aircraft is repaired, the aircraft is removed from service.

(3 & 5) Thunderstorms and general rain showers introduce the possibility of rain water leaking past the fuel filler caps and going directly into the fuel tanks. Rain water contamination of the fuel tanks is a very serious and persistent problem that can occur with catastrophic results.

(6) Bird and animal nests and bird droppings left in place can invite deterioration of painted surfaces and corrosion of the structural elements of the aircraft, and may restrict the proper movement of the controls and control surfaces, and possibly ignite the nesting material causing a fire.

The safety and environmental concerns associated with the remaining hazards of (7) freezing rain, (8) frost, (9) ice, (10) snow, and (11) extreme cold, are outlined below:

(7, 8, 9, & 10) Besides being against all federal regulations and established safe operations, attempting to fly an aircraft with freezing rain, frost, ice, or snow on the wings, fuselage and the horizontal and vertical stabilizers most likely will result in injury and/or death to the occupants and cause very extensive damage to the aircraft. Presence of freezing rain, frost, ice, snow frost on the aircraft changes the lift and stall characteristics for that particular aircraft. Changes in the aerodynamics of the aircraft alters all the dynamic handling characteristics of the aircraft, which makes the plane operate outside the envelope of the pilots operating handbook. Operating outside the limitations establish by the pilot's operating handbook is unsafe and introduces numerous opportunities for accident, injury and death. Freezing rain, or frost, or ice, or snow on the aircraft may very well restrict the aircraft from generating the necessary lift required to take off and maintain altitude. In some instances the pilot scraps off as much of the freezing rain, or frost, or ice, or snow as the pilot can reach and then just departs with some of the freezing rain, frost, ice, or snow remaining on the aircraft. Sometimes the departure is successful and sometimes the attempted departure is not successful. It is extremely costly and time consuming to remove the freezing rain, or frost, or ice, or snow from the aircraft. The most conventional method to remove the freezing rain, or frost, or ice, or snow from an aircraft is to tow the aircraft to a heated building, or douse the wings and tail section with a deicer, or just wait until the sun's heat removes the culprit.

(10) Heavy snow loads on the wings and fuselage of an aircraft can cause structural damage to the aircraft.

(7, 8, 9, 10) One very serious caveat to removing the freezing rain, or frost, or ice, or snow by moving the aircraft to a heated building or waiting for the sun to melt the frost off the aircraft is the possibility that the melted water may freeze at altitude. Refreezing the melted frost (water) at altitude may render the controls inoperable.

(11) Extreme cold weather can render the control cables and moving parts, which affect the control surfaces, very stiff and difficult to move, introducing excessive wear and the possibility for damage to the control mechanisms of the aircraft.

At the present time there does not appear to be any concept, product, application or process that completely or effectively addresses the eleven safety and environmental hazards that expose the aircraft, pilots and or passengers to costly damage and serious injury and possible death.

There are vendors that sell canvas covers that lay over the windows and are attached to the outside of smaller aircraft in an attempt to restrict the sun from entering the cockpit. This application appears to be marginally effective at best. There are also vendors that sell custom fit reflective material that is installed in the inside window openings of an aircraft. This reflective material must be cut to the exact size of the window, and then, from the inside, you press the specific sized reflective material for that particular window opening into the area around the window, on the inside of the aircraft. This method is used with smaller aircraft. The reflective material is on the inside of the Plexiglas window, and a great deal of heat builds up between the actual reflective material and the inside of the window or Plexiglas, causing great stress to the window or Plexiglas and reducing its life.

No application today addresses the safety and environmental hazards associated with all the elements: sun, heat, thunderstorms, hail, rain and fuel contamination, bird and animal nesting and droppings, freezing rain, frost, ice, snow and extreme cold conditions.

The Aircraft & motor vehicle protection system invention, will eliminate the damage and safety concerns associated with exposure of the aircraft and ground vehicle to the sun, heat, thunderstorms, hail, rain and fuel contamination, bird and animal nesting and droppings, freezing rain, frost, ice, snow and extreme cold.

### BRIEF SUMMARY OF THE INVENTION

The Invention (The Aircraft & motor vehicle protection system) consists of one or more inflatable/deflatable blanket modules secured and attached to other inflatable/deflatable blanket modules to form a complete system. Each inflatable/deflatable blanket module shall consist of a Bottom layer or layers of cushioned material; a Inner layer or layers of inflatable/deflatable bubble material that can be inflated or deflated as appropriate with air or other suitable gaseous material, that is positioned just above the Bottom layer; a Heated layer or layers of material that can be heated, positioned just above the Inner inflatable/deflatable bubble layer or layers; and a Top layer or layers of material that is moisture and water proof, and provides UV protection, and sun (heat) “reflectability”, and with the capacity, durability, flexibility and strength to resist or stop projectiles, debris and hail from penetrating the entire blanket; all the layers, when sandwiched and secured together, comprise an individual inflatable/deflatable blanket module. When the individual inflatable/deflatable blanket modules are connected or attached to other individual inflatable/deflatable blanket modules, those inflatable/deflatable blanket modules comprise an entire Aircraft & motor vehicle protection system (Invention) for aircraft and motor vehicles when parked or tied down outside exposed to the elements. The entire system (Invention) when installed on the entire aircraft or motor vehicle provides protection from all eleven environmental and/or safety concerns associated with exposure to the sun, heat, thunderstorms, hail, rain and fuel contamination, bird and animal nesting and droppings, freezing rain, frost, ice, snow and extreme cold.

### DETAILED DESCRIPTION OF THE INVENTION

The Invention (System) consists of an individual inflatable/deflatable blanket system of such design, configuration and size as to completely cover the exposed surfaces of an aircraft. There will be different sizes of individual inflatable/deflatable blanket systems for various size and style of aircraft. This application is also suitable for ground vehicles.

Each individual inflatable/deflatable blanket system (invention) consists of one or more individual inflatable/deflatable blanket modules, connected together in a suitable manner as to comprise of, when connected together, the complete larger inflatable/deflatable blanket invention (system) that covers the entire fuselage and wings of the aircraft.

The inflatable/deflatable blanket modules, which comprise the invention (System), can be installed on aircraft and then inflated or deflated when necessary to protect the aircraft against thunderstorms and hailstorms and as necessary, to remove freezing rain, frost, ice, and snow from the aircraft and eliminate bird nesting and droppings and eliminate fuel contamination or control surface freezing possibilities.

Each inflatable/deflatable blanket module that comprise the invention (System) may consist of the following elements:

The Bottom layer, the Inner layer, the Heated layer, and the Top layer.

The Bottom layer of the inflatable/deflatable blanket module consists of a layer or layers of soft material suitable to protect the aircraft's surface and appendages from abrasion or scratches as the result of modular inflatable/deflatable blanket material movement.

The Inner layer or layers of the inflatable/deflatable blanket module shall be designed in such a manner and size so as the components of each individual Inner layer or layers of the inflatable/deflatable blanket module shall have numerous individual air cells within each Inner layer portion of the inflatable/deflatable blanket module. Each individual Inner layer of the inflatable/deflatable blanket module, which is located above the Bottom layer and below the Heated and/or top layer, shall consist of a suitable number of individual air cells, of suitable size, that will be positioned adjacent to and above and below the other air cells so that there are multiple layers and rows of air cells within each individual Inner layer portion of the inflatable/deflatable blanket module. The number of rows and layers of individual air cells within each individual Inner layer of the blanket modules shall be of such number and size that each individual cell within the inflatable/deflatable blanket module are suitable in size and number as to protect the aircraft from damage from hail and other foreign objects striking the aircraft. Each Inner layer in each individual inflatable/deflatable blanket module will have multiple layers of air cells, and each air cell layer within each inflatable blanket module shall be designed so it may be inflated and/or deflated individually for only that particular layer or all the layers together. The Inner layer or layers of the inflatable/deflatable blanket module shall have multiple air cells and layers of air cells of suitable material that can be inflated with air to a suitable strength (PSI) to protect the aircraft during warmer weather periods and/or deflated as necessary to accommodate winter conditions or to actually remove the invention (System) from the aircraft to be stowed.

The Heated layer portion of the inflatable blanket module of the invention (System) shall consist of a suitable heating element or elements that will have the capacity to heat the entire invention (System) or portions of the entire system. There shall be a manual or automatic means of controlling the intensity and temperature of the heat delivered to the Heated layer or layers. There shall be means of turning the Heated layer on and/or off, either manually or automatically.

The Top layer or layers of the invention (System) will consist of a suitable material that shall be moisture and water proof, and provides UV protection, and sun (heat) “reflectability”, and be of sufficient durability, flexibility and strength as to resist or stop projectiles, debris and hail from penetrating the top layer or layers and the material below the outer layer or layers.

All layers when sandwiched together comprise the inflatable/deflatable module, and when each inflatable/deflatable module is secured and attached to other inflatable/deflatable modules, all the inflatable/deflatable modules together, comprise the overall invention (System).

The inflatable/deflatable modules that consist of the overall invention (System) shall be constructed and secured together in such a fashion that each layer, which may consist of, the Bottom layer or layers, the Inner layer or layers, the Heated layer or layers or the Top layer or layers, of the inflatable/deflatable module, that comprise the entire invention (System), may be permanently secured together or each of the layer or layers can be removed from the other layers within each inflatable/deflatable module and be replaced if damaged or when there is evidence of deterioration from use. For example, an entire inflatable/deflatable module can be constructed so each of the layers are permanently sandwiched (laminated) together or they may be constructed so the layers may be disassembled, and any layer of the module can be removed and replaced.

The invention (System), once installed, shall be inflated and deflated using suitable methods to inflate and deflate the invention (System).

The invention shall have a suitable means and method to inflate and deflate the Inner layers of the entire protection invention (System) as one homogenized single system (all at once), or a suitable means and method to individually inflate and deflate the various layers of cells with in each Inner layer of each individual inflatable blanket module that comprise the entire invention (System).

The invention shall have a suitable means to monitor the air pressure, when inflating the Inner layer or layers, so as not to over-inflate the invention and to supply additional air if the air pressure in the Inner layer or layers drops to a predetermined air pressure.

The invention shall have a suitable means to supply heat to all the Heat layer or layers of all the inflatable/deflatable blanket modules as one homogenized activity, applying heat to the entire invention (System), or supply heat to only selected inflatable blanket modules within the entire invention (System). For example, it may be desirable to apply heat to only the inflatable/deflatable modules located on the wing portions of the entire invention (System).

The invention shall have a suitable means of securing the individual inflatable/deflatable blanket modules to each other.

Each individual inflatable blanket module, that comprise the invention (System), will always comprise a Bottom layer or layers, the Inner layer or layers, and a Top layer or layers, but it may also include a Heated layer or layers that will be located below the Top layer or layers and above the Inner layer or layers.

The various layers that comprise each of the individual inflatable/deflatable blanket modules of the invention shall be arranged in any fashion, order and method that will provide suitable protection to the aircraft.

There shall be a suitable means of securing the Bottom, Inner, Heated and Top layer or layers that comprise the individual inflatable/deflatable module, to each other.

The Bottom layer or layers will be secured to the Inner layer or layers; the Inner layer or layers will be secured to the Bottom layer and the Heated layer or layers or Top layer or layers. The Heated layer or layers will be secured to the Inner layer or layers and the Top layer or layers. The Top layer will be secured to either the Inner layer or layers or the Heated layer or layers.

The invention shall have a suitable means of securing the entire inflatable blanket invention (System) to the aircraft.

The invention shall have a suitable means of providing an alarm or notification, on-site or remotely, in the event the invention is vandalized, any unauthorized attempt is made to remove the system from the aircraft or vehicle, and or if the invention's integrity is compromised as the result of a failure of any of the functioning systems that comprise the invention.

How the Invention (System) Works:

The inflatable/deflatable multiple layered blanket invention (system) is installed on the aircraft with the Bottom layer or layers of the invention resting on the aircraft surface, and Inner layer or layers of the inflatable/deflatable multiple layered blanket modules are individually or group inflated by a suitable means to inflate the blanket modules in anticipation of a thunderstorm or hailstorm or to protect the aircraft from debris caused as the result of strong winds. Should it hail on the aircraft, the inflatable/deflatable blanket invention (System) absorbs the impact of the hail and protects the entire exterior surfaces of the aircraft from hail damage or debris damage.

During cooler or colder weather the invention is installed on the aircraft, same as above, but in this scenario the invention (System) is left in a deflated state during the cooler and colder months, where the aircraft is susceptible freezing rain, frost, ice or snow accumulations. Should the aircraft be subjected to an accumulation of freezing rain, frost, ice or snow that has collected on the aircraft, during the pre-flight process, the pilot or responsible crew member simply inflates the invention (System) and the freezing rain, frost, ice or snow accumulations will be dislodged from the aircraft.

During periods where extreme fluctuations in the weather is possible the invention (System) is installed on the aircraft, same as above, but in this scenario the lower layers of air cells within the Inner layer or layers of the inflatable blanket modules, that comprise of the entire invention (System), are left in the inflated state to protect against hail, and the top layers of air cells within the Inner layer or layers portion of the inflatable blanket modules are left deflated, allowing the upper layers of air cells of the Inner blanket module to be inflated, if necessary, during pre-flight process, to dislodge any freezing rain, frost, ice or snow that may have accumulated on the aircraft. In this mode the invention is capable of protecting the aircraft simultaneously from numerous safety and environmental hazards.

The invention (System), whether inflated, deflated, or half inflated and half deflated, eliminates the danger of the melting activity that allows the melted water to migrate into control surfaces, hinges, cables and additional moving parts that may again freeze at altitude. The refreezing of melted water at altitude introduces a very dangerous and life threatening condition.

The invention's (System's) top layer or layers with its waterproof, moisture proof, insulated covering protects the interior and the avionics of the aircraft during winter and summer. The invention (System) reduces the interior temperature during hotter months and reduces heat loss during the colder months.

The invention (System) protects against the possibility of rain water leaking past the fuel filler caps and going directly into the fuel tanks. Rain water contamination of the fuel tanks is a very serious and persistent problem that can occur which can produce catastrophic results such as an engine(s) failure during flight.

When utilized in extremely brutal weather conditions with the possibilities of large accumulations of freezing rain, ice, or very heavy snow loads accumulating on the aircraft, where the wings may be stressed to the point of damage as the result of the weight of the heavy freezing rain, ice and snow loads, the invention's (System's) Heated layer or layers may be activated, utilizing suitable heating methods to heat the Heated layer or layers, thus melting the freezing rain, ice or snow as it falls on the aircraft. The Heated layer or layers shall have a suitable method of controlling the on and off cycles of the heated layer or layers, depending on the ambient air temperatures and weather forecasts.

During periods of extremely cold temperatures the invention's (System's) Heated layer or layers may be activated to provide a barrier between the cold weather and the fuel cells.

The lightweight invention (System) shall have a means where the invention can be rapidly deflated, removed from the aircraft, folded and secured for flight in a matter of minutes, using the convenient storage container.

The invention (System) is comprised of various sized inflatable/deflatable blanket modules designed specifically for the protection of a specific aircraft or a series of aircraft. The unique design allows for the protection of the aircraft regardless of the location of antennas or other protruding appendages. Each of the blanket system modules is either a free stand-alone blanket system module or is deployed in concert with another blanket system module. For example, one blanket system module may cover one wing on a smaller aircraft, but two or more blankets may be needed to protect the wing on a larger aircraft. The number of inflatable/deflatable blanket modules, that comprise the entire invention (System), needed to completely protect the fuselage of an aircraft may vary based on the size of the aircraft. The actual size and form of the inflatable blanket modules and the specific aircraft configuration and size determines the number and size of inflatable blanket modules that comprise of the complete invention (System) needed to protect the aircraft. The invention (System) needed to protect a particular aircraft comprises the total inflatable/deflatable blanket modules, with needed layers, connected together, with a suitable method and means to operate, inflate and/or deflate the Inner layer or layers, a suitable heating system that heats the Heated layer or layers, and the Top protective layer or layers.

If there is a system failure in any of components of the entire invention, or there is attempted vandalism or attempted theft of the invention that has been deployed to protect an aircraft or vehicle, an alarm and or notification will be initiated on-site and or remotely indicating the system failure of the invention.

1. I claim that my invention comprises a complete system of protection for an aircraft and for a ground vehicle and the invention has three or more layers of protective elements to protect the aircraft or ground vehicle against the numerous environmental and safety hazards of sun, heat, thunderstorms, hail, rain and fuel contamination, bird and animal nesting and droppings, freezing rain, frost, ice, snow and extreme cold. The three or more layers are:
the Bottom layer or layers,
the Inner layer or layers,
the Heated layer or layers,
and the Top layer or layers.

2. I claim that my invention, which is utilized for the protection of an aircraft and for a ground vehicle, has a Bottom layer or layers of soft protective material to protect the surface of the aircraft against abrasions or scratches from the movement of the protection system.

3. I claim that my invention, which is utilized for the protection of an aircraft and for a ground vehicle, has a Inner layer or layers that can be inflated or deflated as necessary to protect the aircraft or vehicle from the numerous environmental and safety hazards.

4. I claim that my invention, which is utilized for the protection of an aircraft and for a ground vehicle, has a means of providing a suitable air supply or other suitable gaseous supply necessary to inflate any or all of the Inner layer air cells on demand, either manually or automatically from either on-site activity or remotely.

5. I claim that my invention, which is utilized for the protection of an aircraft and for a ground vehicle, has a means to inflate any or all the air cells layers in the Inner layer or layers individually or inflate any or all the air cell layers in the Inner layer or layers all at one time from either on-site activity or remotely.

6. I claim that my invention, which is utilized for the protection of an aircraft and for a ground vehicle, has the means to monitor the air pressure within the Inner layer or layers and to initiate the air supply to start and stop at predetermined limits.

7. I claim that my invention, which is utilized for the protection of an aircraft and for a ground vehicle, has the means to deflate any or all air cell layers in the Inner layer or layers individually or all the air cell layers in the Inner layer or layers all at one time.

8. I claim that my invention, which is utilized for the protection of an aircraft and for a ground vehicle, has the ability to rapidly deflate any and all air cells in the Inner layer or layers in the system.

9. I claim that my invention, which is utilized for the protection of an aircraft and for a ground vehicle, has a Heated layer or layers that can be turned on to melt freezing rain, ice and snow from the aircraft or turned off either manually or automatically from either on-site activity or remotely.

10. I claim that my invention, which is utilized for the protection of an aircraft and for a ground vehicle, has a suitable heating element or heating elements within the Heating layer to heat the entire invention (System) or portions of the invention (System).

11. I claim that my invention, which is utilized for the protection of an aircraft and for a ground vehicle, shall have a suitable means to supply heat to the entire Heat layer or layers of all the inflatable/deflatable blanket modules as one homogenized activity, applying heat to the entire invention (System), or apply heat to only selected inflatable blanket modules within the entire invention (System)

12. I claim that my invention, which is utilized for the protection of an aircraft and for a ground vehicle, has a suitable method to monitor the outside air temperature and as the result of the outside air temperature the Heated layer or layers can be turned on and off on command, either manually or automatically and either on-site or remotely.

13. I claim that my invention, which is utilized for the protection of an aircraft and for a ground vehicle, has an outer layer or layers that have a suitable material that provides UV protection, and sun (heat) “reflectability”, and with the capacity to protect the aircraft from heat and UV damage, and with sufficient durability, flexibility and strength to resist or stop projectiles, debris and hail.

14. I claim that my invention, which is utilized for the protection of an aircraft and for a ground vehicle, has a suitable method to secure the bottom, Middle, Heated and Top layers to each other in a secure fashion to form a complete inflatable/deflatable blanket module.

15. I claim that my invention, which is utilized for the protection of an aircraft and for a ground vehicle, may have the capacity to remove and to replace any and all layers of the inflatable/deflatable blanket module that comprises of the entire system.

16. I claim that my invention, which is utilized for the protection of an aircraft and for a ground vehicle, may have the capacity to have all the layers permanently attached together.

17. I claim that my invention, which is utilized for the protection of an aircraft and for a ground vehicle, has a suitable method to attach multiple inflatable/deflatable modules together to form a complete protection invention (system).

18. I claim that my invention, which is utilized for the protection of an aircraft and for a ground vehicle, has a suitable method to secure a complete protection system to the aircraft.

19. I claim that my invention, which is utilized for the protection of an aircraft and for a ground vehicle, shall have a suitable means of providing an alarm and or notification, on-site or remotely, in the event the invention, once deployed to protect an aircraft of vehicle, is vandalized, or any unauthorized attempt is made to remove the system from the aircraft or vehicle, and or if the invention's integrity is compromised as the result of a failure of any of the functioning systems that comprise the invention.
